(19) United States
(12) Patent Application Publication
(10) Pub. No.: US 2026/0164390 A1
(43) Pub. Date: Jun. 11, 2026

(54) Secure Access Point Association

(71) Applicant: Ofinno, LLC, Reston, VA (US)

(72) Inventors: Tuncer Baykas, Reston, VA (US); Jeongki Kim, Fairfax, VA (US); Esmael Hejazi Dinan, McLean, VA (US); Leonardo Alisasis Lanante, Reston, VA (US)

(73) Assignee: Ofinno, LLC, Reston, VA (US)

(21) Appl. No.: 19/465,549

(22) Filed: Jan. 30, 2026

Related U.S. Application Data
(63) Continuation of application No. PCT/US2024/040396, filed on Jul. 31, 2024.
(60) Provisional application No. 63/530,083, filed on Aug. 1, 2023.
(60) Provisional application No. 63/564,543, filed on Mar. 13, 2024.

(51) Int. Cl. H04W 60/04; H04W 76/15

(52) U.S. Cl. CPC H04W 60/04; H04W 76/15

(57) ABSTRACT

A station (STA) receives from an access point (AP) via a first link, a first frame indicating a second link via which performance of an association procedure with the AP is permitted. The STA transmits an association request to the AP, via the second link.

### CROSS-REFERENCE TO RELATED APPLICATIONS

This application is a continuation of International Application No. PCT/US 2024/040396, filed Jul. 31, 2024, which claims the benefit of U.S. Provisional Application No. 63/530,083, filed Aug. 1, 2023, and U.S. Provisional Application No. 63/564,543, filed Mar. 13, 2024, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4 illustrates an example of a Quality of Service (QoS) null frame indicating buffer status information.

FIG. 5 illustrates an example format of a physical layer (PHY) protocol data unit (PPDU).

FIG. 6 illustrates an example that includes buffer status reporting by STAs, scheduling by an AP of uplink multi-user (MU) transmissions, and transmission of scheduled uplink transmissions by the STAs.

FIG. 7 illustrates an example reference model for a multi-link device (MLD).

FIG. 8 illustrates an example of an AP MLD and an associated non-AP MLD.

FIG. 9 illustrates an example of a multi-link setup between an AP MLD and a non-AP MLD.

FIG. 10 illustrates an example of a traffic identifier (TID)-to-link mapping in a multi-link communication environment.

FIG. 11 illustrates an association procedure according to the IEEE 802.11 standard.

FIG. 12 illustrates an example WLAN communication scenario.

FIG. 13 is an example that illustrates an association procedure according to an embodiment.

FIG. 14 is an example that illustrates an association procedure according to another embodiment.

FIG. 15 is an example that illustrates an association procedure according to another embodiment.

FIG. 16 is an example that illustrates an association procedure according to another embodiment.

FIG. 17 illustrates an example operation element which may be used in embodiments.

FIG. 18 illustrates an example process according to an embodiment.

FIG. 19 illustrates an example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages are presented for example purposes only. The disclosed architecture is sufficiently flexible and configurable, such that it may be utilized in ways other than those shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, application-specific integrated circuits (ASICs); field programmable gate arrays (FPGAs); and complex programmable logic devices (CPLDs). Computers, microcontrollers, and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

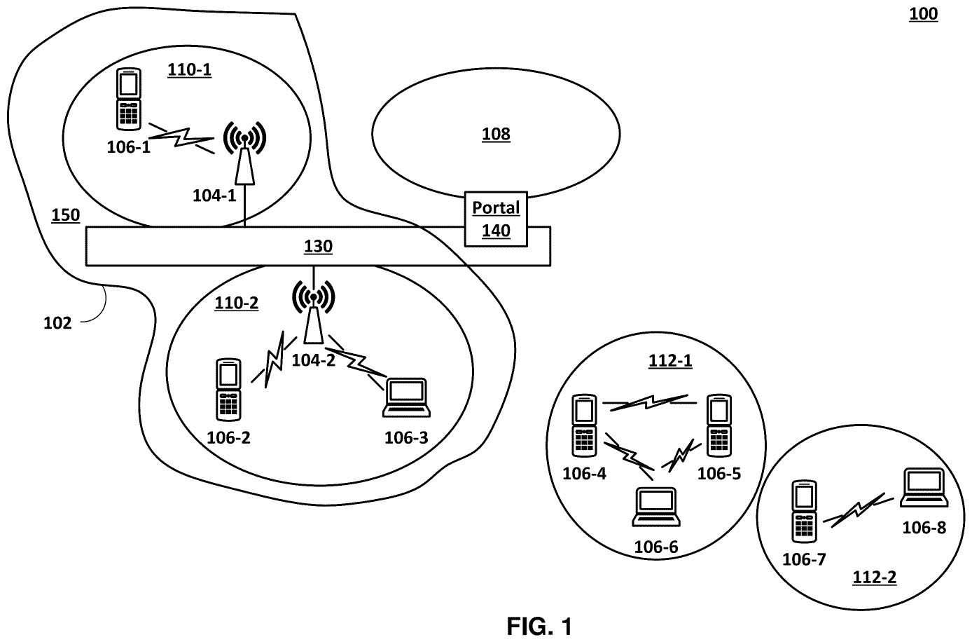

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PLCP service data unit (PSDU). For example, the PSDU may include a PHY Convergence Protocol (PLCP) preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax, 802.11be and/or 802.11ad and 802.11ay standard amendments may be transmitted over the 2.4 GHz, 5 GHz, 6 GHz and/or 60 GHz bands. The PPDUs may be transmitted over a physical channel.

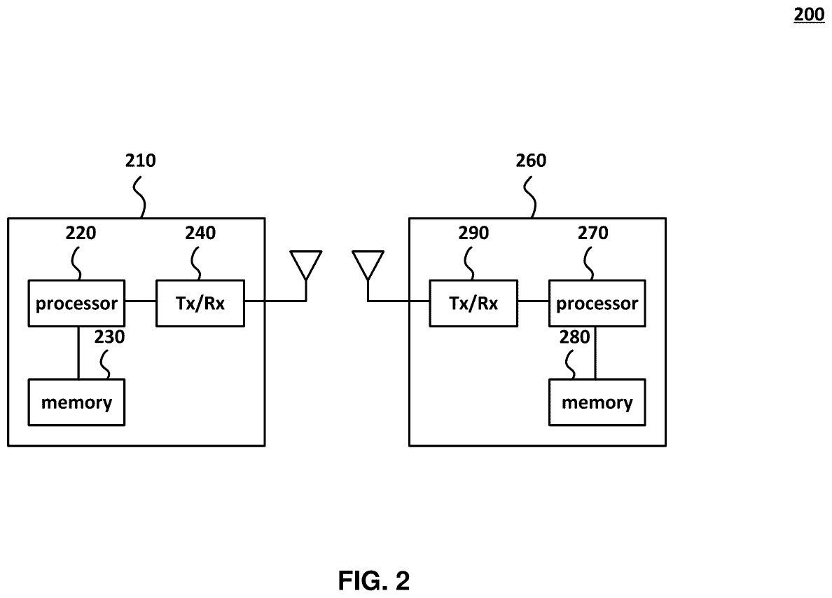

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

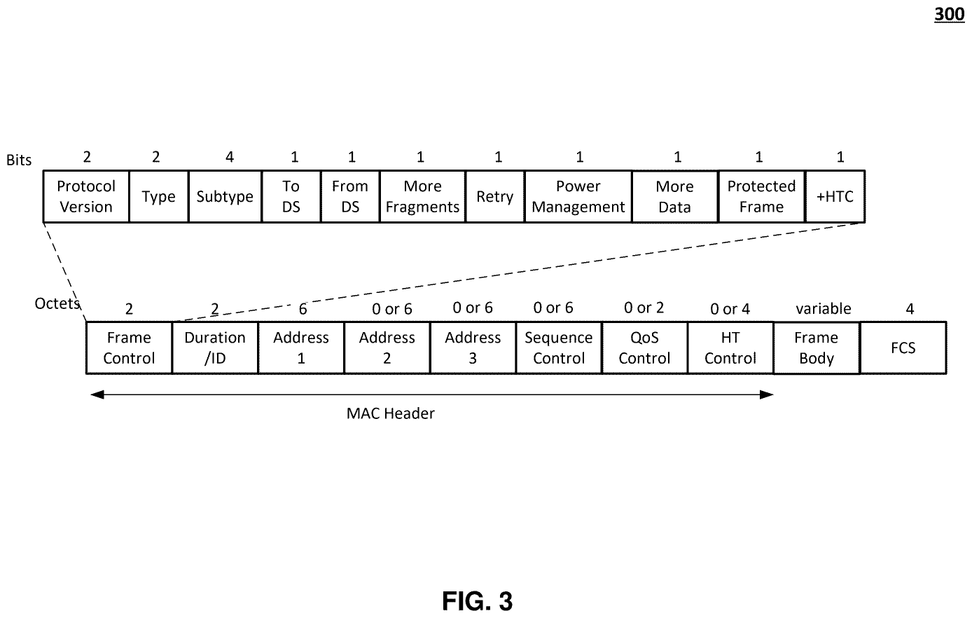

FIG. 3 illustrates an example format of a MAC frame. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control field includes the following subfields: protocol version, type, subtype, “To DS”, “From DS”, “More Fragments”, retry, power management, “More Data, protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types:
control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS data frame, which is a data frame that contains a QoS control field in its MAC header. The second MSB of the subtype field, bit 6(B6) of the frame control field, when set to 1 in data subtypes, indicates a data frame that contain no frame body field.

The “To DS” subfield indicates whether a data frame is destined to the distribution system (DS). The “From DS” subfield indicates whether a data frame originates from the DS.

The “More Fragments” subfield is set to 1 in all data or management frames that have another fragment to follow the MAC service data unit (MSDU) or MAC management protocol data unit (MMPDU) carried by the MAC frame. The “More Fragments” subfield is set to 0 in all other frames in which the “More Fragments” subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The “More Data” subfield indicates to a STA in power save (PS) mode that bufferable units (BUs) are buffered for that STA at the AP. The “More Data” subfield is valid in individually addressed data or management frames transmitted by an AP to a STA in PS mode. The “More Data” subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on the frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), with the 2 most significant bits (MSB) set to 1. In other frames sent by STAs, the duration/ID field contains a duration value (in microseconds) which is used by a recipient to update a network allocation vector (NAV). The NAV is a counter that indicates to a STA an amount of time during which the STA must defer from accessing the shared medium.

Up to four address fields may be present in the MAC frame format. The address fields are used to indicate the basic service set identifier (BSSID), source address (SA), destination address (DA), transmitting address (TA), and receiving address (RA). Certain frames may not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield, and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. The frame body may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

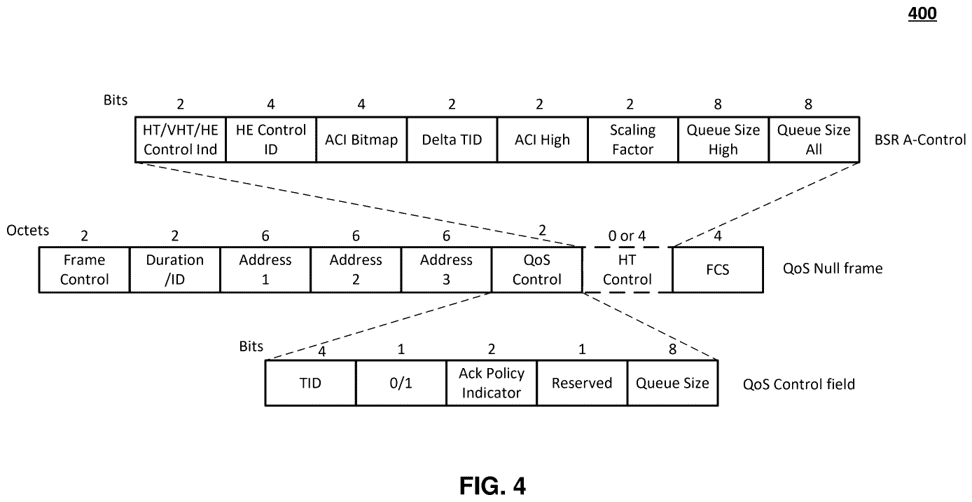

FIG. 4 illustrates an example of a QoS null frame indicating buffer status information. A QoS null frame refers to a QoS data frame with an empty frame body. A QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an ack policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the acknowledgment policy followed upon delivery of the MPDU (e.g., normal ack, implicit block ack request, no ack, block ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine t TXOP duration assigned to the STA or to determine the uplink (UL) resources assigned to the STA.

In a frame sent by or to a non-High Efficiency (non-HE) STA, the following rules may apply to the queue size value:
The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.
A queue size value of 0 is used solely to indicate the absence of any buffered traffic in the queue used for the specified TID.
A queue size value of 254 is used for all sizes greater than 64 768 octets.
A queue size value of 255 is used to indicate an unspecified or unknown size.

In a frame sent by an HE STA to an HE AP, the following rules may apply to the queue size value.

The queue size value, QS, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14-B15 of the QoS control field and an unscaled value, UV, in bits B8-B13 of the QoS control field. The scaling factor subfield provides the scaling factor, SF.

A STA obtains the queue size, QS, from a received QoS control field, which contains a scaling factor, SF, and an unscaled value, UV, as follows:
QS=
16×UV, if SF is equal to 0;
1024+256×UV, if SF is equal to 1;
17 408+2048×UV, if SF is equal to 2;
148 480+32 768×UV, if SF is equal to 3 and UV is less than 62;
>2 147 328, if SF equal to is 3 and UV is equal to 62;
Unspecified or Unknown, if SF is equal to 3 and UV is equal to 63.

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 us to 8160 us in increments of 32 us.

The HT control field may include a BSR control subfield which may contain buffer status information used for UL MU operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories (ACs) for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0 otherwise, except that if the ACI bitmap subfield is 0 and the delta TID subfield is 3, then the buffer status of all 8 TIDs is included.

The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield. The ACI to AC mapping is defined as ACI value 0 mapping to AC_BE, ACI value 1 mapping to AC_BK, ACI value 2 mapping to AC_VI, and ACI value 3 mapping to AC_VO.

The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all ACs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254 ×SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

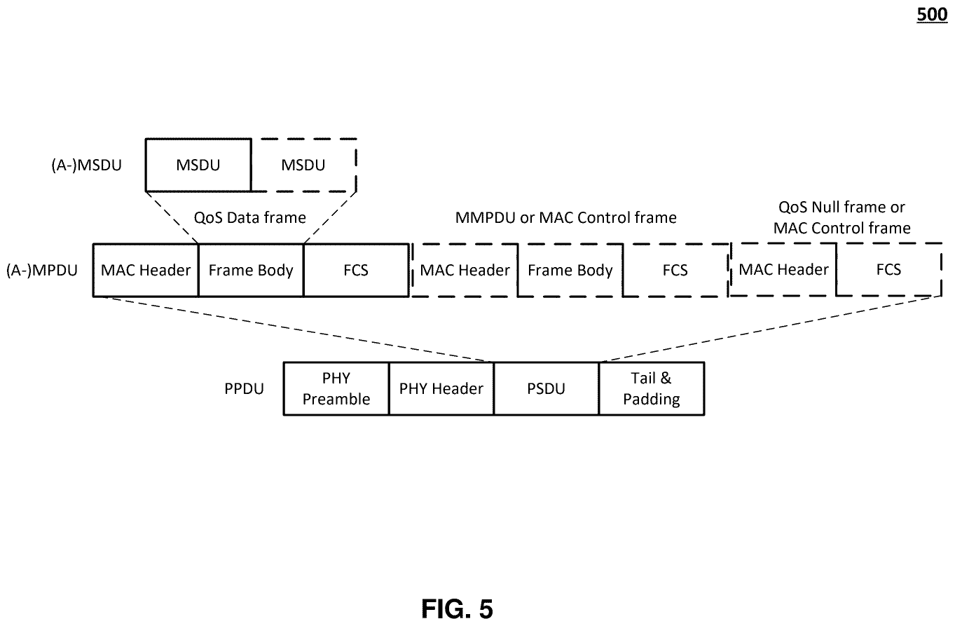

FIG. 5 illustrates an example format of a PPDU. As shown, the PPDU may include a PHY preamble, a PHY header, a PSDU, and tail and padding bits.

The PSDU may include one or more MPDUs, such as a QoS data frame, an MMPDU, a MAC control frame, or a QoS null frame. In the case of an MPDU carrying a QoS data frame, the frame body of the MPDU may include a MSDU or an A-MSDU.

By default, MSDU transport is on a best-effort basis. That is, there is no guarantee that a transmitted MSDU will be delivered successfully. However, the QoS facility uses a traffic identifier (TID) to specify differentiated services on a per-MSDU basis.

A STA may differentiate MSDU delivery according to designated traffic category (TC) or traffic stream (TS) of individual MSDUs. The MAC sublayer entities determine a user priority (UP) for an MSDU based on a TID value provided with the MSDU. The QoS facility supports eight UP values. The UP values range from 0 to 7 and form an ordered sequence of priorities, with 1 being the lowest value, 7 the highest value, and 0 falling between 2 and 3.

An MSDU with a particular UP is said to belong to a traffic category with that UP. The UP may be provided with each MSDU at the medium access control service access point (MAC SAP) directly in an UP parameter. An A-MPDU may include MPDUs with different TID values.

A STA may deliver buffer status reports (BSRs) to assist an AP in allocating UL MU resources. The STA may either implicitly deliver BSRs in the QoS control field or BSR control subfield of any frame transmitted to the AP (unsolicited BSR) or explicitly deliver BSRs in a frame sent to the AP in response to a BSRP Trigger frame (solicited BSR).

The buffer status reported in the QoS control field includes a queue size value for a given TID. The buffer status reported in the BSR control field includes an ACI bitmap, delta TID, a high priority AC, and two queue sizes.

A STA may report buffer status to the AP, in the QoS control field, of transmitted QoS null frames and QoS data frames and, in the BSR control subfield (if present), of transmitted QoS null frames, QoS data frames, and management frames as defined below.

The STA may report the queue size for a given TID in the queue size subfield of the QoS control field of transmitted QoS data frames or QoS null frames; the STA may set the queue size subfield to 255 to indicate an unknown/unspecified queue size for that TID. The STA may aggregate multiple QoS data frames or QoS null frames in an A-MPDU to report the queue size for different TIDs.

The STA may report buffer status in the BSR control subfield of transmitted frames if the AP has indicated its support for receiving the BSR control subfield.

A High-Efficiency (HE) STA may report the queue size for a preferred AC, indicated by the ACI high subfield, in the queue size high subfield of the BSR control subfield. The STA may set the queue size high subfield to 255 to indicate an unknown/unspecified queue size for that AC.

A HE STA may report the queue size for ACs indicated by the ACI bitmap subfield in the queue size all subfield of the BSR control subfield. The STA may set the queue size all subfield to 255 to indicate an unknown/unspecified BSR for those ACs.

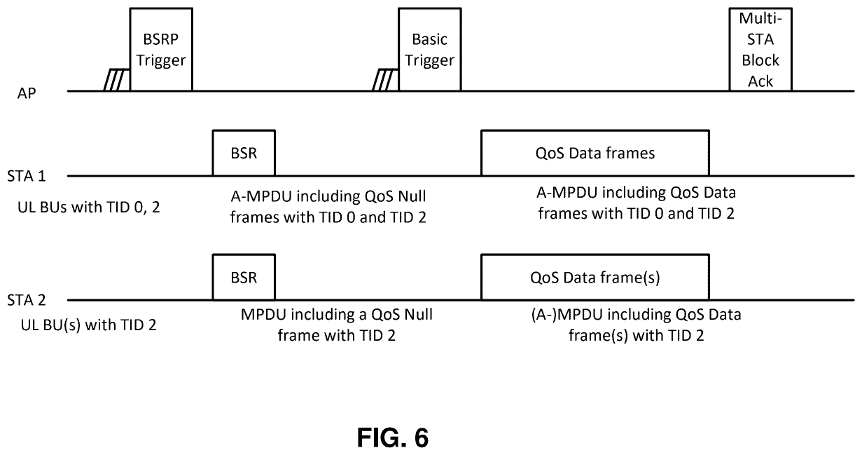

FIG. 6 illustrates an example that includes buffer status reporting by STAs, scheduling by an AP of uplink multi-user (MU) transmissions, and transmission of scheduled uplink transmissions by the STAs.

As shown, the AP may solicit one or more associated STAs (STA 1 and STA 2) for buffer status by sending a buffer status report poll (BSRP) trigger frame. Upon receiving the BSRP trigger frame, STA 1 and/or STA 2 may each generate a trigger-based (TB) PPDU if the BSRP trigger frame contains, in a User Info field, the 12 LSBs of the STA's AID.

STA 1 and/or STA 2 may each include in the TB PPDU one or more QoS null frames. The one or more QoS null frames may contain one or more QoS control fields or one or more BSR control subfields.

As described earlier, a QoS control field may include a queue size subfield for a TID for which the STA has a queue size to report to the AP. For example, as shown in FIG. 6, STA 1 may respond to the BSRP trigger frame from the AP by transmitting an A-MPDU including multiple QoS null frames. The QoS null frames each indicates, in its respective QoS control field, a queue size for a respective TID, e.g., TID 0 and TID 2. Similarly, STA 2 may respond to the BSRP trigger frame by transmitting an MPDU including a QoS null frame, which indicates a queue size for TID 2 in its QoS control field.

A BSR control subfield may include a queue size all subfield indicating the queue size for the ACs, indicated by the ACI bitmap subfield, for which the STA has a queue size to report to the AP if the AP has indicated its support for receiving the BSR control subfield. The STA sets a delta TID, a scaling factor, an ACI high, and the queue size high subfields of the BSR Control subfield.

On receiving the BSRs from STA 1 and STA 2, the AP may transmit a basic trigger frame to allocate UL MU resources to STA 1 and STA 2. In response, STA 1 may transmit a TB PPDU containing QoS data frames with TID 0 and TID 2 and STA 2 may transmit a TB PPDU containing one or more QoS data frame(s) with TID. The AP may acknowledge the transmitted TB PPDUs from STA 1 and STA 2 by sending a multi-STA block ack frame.

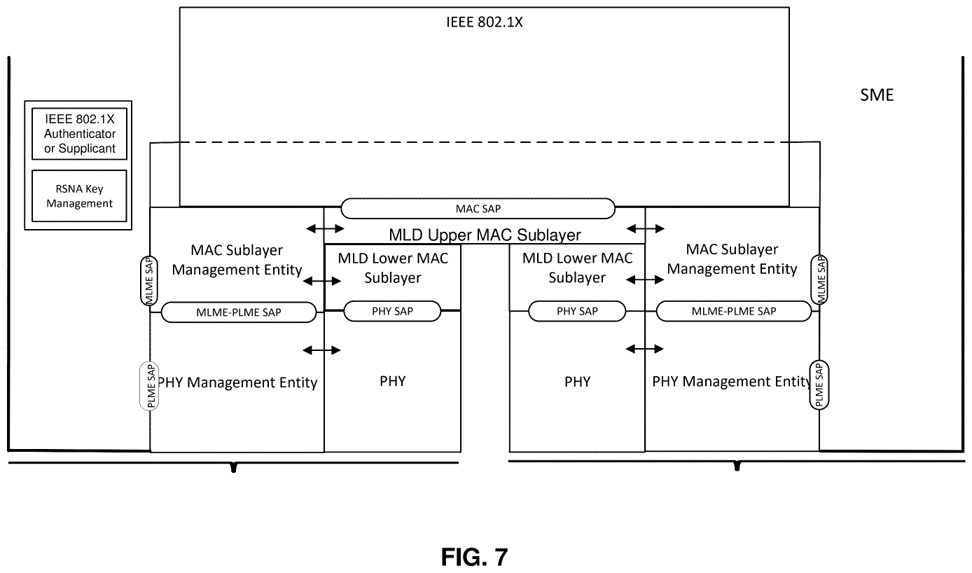

FIG. 7 illustrates an example reference model for a multi-link device (MLD).

An MLD is an entity capable of managing communication over multiple links. The MLD may be a logical entity and may have more than one affiliated station (STA). An MLD may be an access point MLD (AP MLD) where a STA affiliated with the MLD is an AP STA (or an AP). An MLD may be a non-access point MLD (non-AP MLD) where a STA affiliated with the MLD is a non-AP STA (or an STA).

Communication across different frequency bands/channels may occur simultaneously, or not, depending on the capabilities of both of the communicating AP MLD and non-AP MLD.

As shown in FIG. 7, a MLD may have a single MAC service access point (MAC-SAP) to the LLC layer, which includes a MAC data service. The MLD may support multiple MAC sublayers, coordinated by a sublayer management entity (SME). Each AP STA (or non-AP STA) affiliated with an AP MLD (or non-AP MLD) has a different MAC address within the MLD.

The SME is responsible for coordinating the MAC sublayer management entities (MLMEs) of the affiliated STAs of the MLD to maintain a single robust security network association (RSNA) key management entity as well as a single IEEE 802.1X Authenticator or Supplicant for multi-link operation (MLO).

Multi-link operation (MLO) procedures allow a pair of MLDs to discover, synchronize, (de)authenticate, (re)associate, disassociate, and manage resources with each other on any common bands or channels that are supported by both MLDs. The Authenticator and the MAC-SAP of an AP MLD may be identified by the same AP MLD MAC address. The Supplicant and the MAC-SAP of a non-AP MLD may be identified by the same non-AP MLD MAC address.

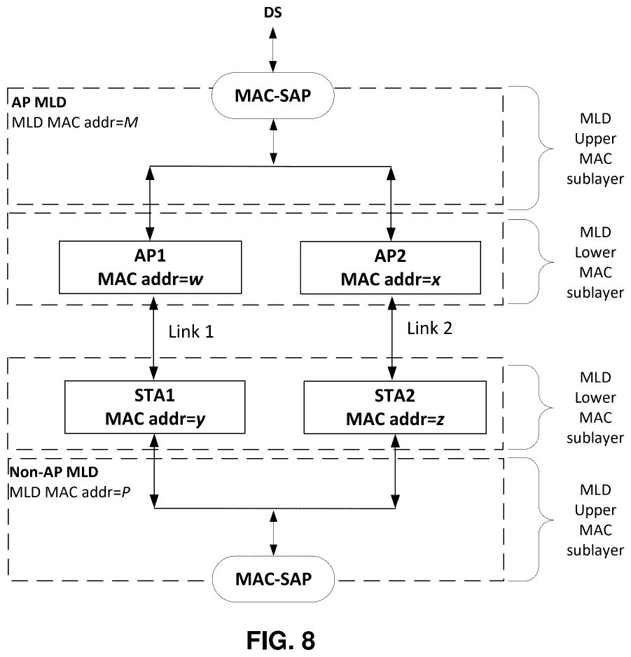

FIG. 8 illustrates an example of an AP MLD and an associated non-AP MLD.

As shown, the AP MLD has two affiliated APs (AP1 and AP2), and the non-AP MLD has two affiliated STAs (STA 1 and STA 2). The AP MLD and the non-AP MLD may be communicatively coupled by two links (Link 1 and Link 2.) Link 1 is established between AP 1 and STA 1, and link 2 is established between AP 2 and STA 2.

Generally, the MAC addresses of an MLD and of its affiliated STAs are different from one another. For example, as shown in FIG. 8, the AP MLD may have MAC address M, AP 1 may have MAC address w, and AP 2 may have with MAC address x. Similarly, the non-AP MLD may have MAC address P, STA 1 may have MAC address y, and STA 2 may have MAC address z.

As shown in FIG. 8, with each MLD, the MAC sublayer may be further divided into an MLD upper MAC sublayer and an MLD lower MAC sublayer. The MLD upper MAC sublayer (MLD) performs functionalities that are common across all links. The MLD lower MAC sublayer performs functionalities that are local to each link. Some of the functionalities require joint processing of both the MLD upper and the MLD lower MAC sublayers.

The MLD upper MAC sublayer functions may include:
Authentication, association, and reassociation (between an AP MLD and a non-AP MLD);
Security association (e.g., pairwise master key security association (PMKSA), pairwise transient key security association (PTKSA)) and distribution of group temporal key (GTK)/integrity GTK (IGTK)/beacon IGTK (BIGTK);
Sequence number (SN)/packet number (PN) assignment for frames to be encrypted by pairwise transient key (PTK) for unicast frames;
Encryption/decryption using PTK for unicast frames;
Selection of the MLD lower MAC sublayer for transmission (TID-to-link mapping);
Reordering of packets to ensure in-order delivery per each Block Ack session;
Block Ack scoreboarding for individually addressed frames (in collaboration with the MLD lower MAC sublayer); optionally, the MLD upper MAC sublayer delivers the Block Ack record on one link to the MLD lower MAC sublayer of other links; and
MLD level management information exchange/indication via the MLD lower MAC sublayer

The MLD lower MAC sublayer functions may include:
Maintenance of link specific GTK/IGTK/BIGTK (between an AP affiliated with the AP MLD and a STA affiliated with the non-AP MLD);
Link-specific encryption/decryption/integrity protection and PN assignment using GTK/IGTK/BIGTK (between an AP affiliated with the AP MLD and a STA affiliated with the non-AP MLD);
Link specific management information exchange/indication (e.g., beacon);
Link specific control information exchange/indication (e.g., RTS/CTS, acknowledgements, etc.);
Power save state and mode;
MAC address filtering for frame reception; and
Block Ack scoreboarding for individually addressed frames (in collaboration with the MLD upper MAC sublayer); optionally, the MLD lower MAC sublayer receives the Block Ack record on the other links from the MLD upper MAC sublayer.

Multi-link (re)setup between a non-AP MLD and an AP MLD may include an exchange of (re)association request/response frames. A (re)association request/response frame exchange for a multi-link setup may include both frames carrying a basic multi-link element.

In the (re)association request frame, the non-AP MLD indicates the links that are requested for (re)setup and the capabilities and operational parameters of the requested links. The non-AP MLD may request to (re)set up links with a subset of APs affiliated with the AP MLD. The links that are requested for (re)setup and the capabilities and operation parameters of requested links are independent of existing setup links with an associated AP MLD and the capabilities and operation parameters of setup links.

In the (re)association response frame, the AP MLD may indicate the requested links that are accepted and the requested links that are rejected for (re)setup and the capabilities and operational parameters of the requested links. The AP MLD may accept a subset of the links that are requested for (re)setup. The (re)association response frame is sent to the non-AP STA, affiliated with the non-AP MLD, that sent the (re)association request frame.

An MLD that requests or accepts multi-link (re)setup for any two links ensures that each link is located on a different nonoverlapping channel. After successful multi-link (re)setup between a non-AP MLD and an AP MLD, the non-AP MLD and the AP MLD set up links for multi-link operation, and the non-AP MLD is (re)associated with the AP MLD. For each setup link, the corresponding non-AP STA affiliated with the non-AP MLD is in the same associated state as the non-AP MLD and is associated with a corresponding AP affiliated with the AP MLD. For each setup link, functionalities between a non-AP STA and its associated AP are enabled unless the functionalities have been extended to the MLD level or specified otherwise.

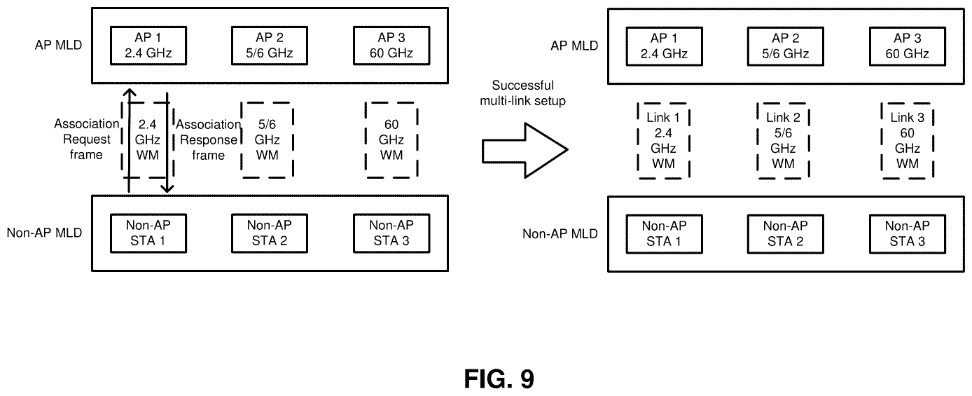

FIG. 9 illustrates an example of a multi-link setup between an AP MLD and a non-AP MLD. As shown, the AP MLD has three affiliated APs: AP 1 operating in the 2.4 GHz band, AP 2 operating in the 5/6 GHz band, and AP 3 operating in the 60 GHz band. The non-AP MLD has three affiliated STAs: non-AP STA 1 operating in the 2.4 GHz band, non-AP STA 2 operating in the 5/6 GHz band, and non-AP STA 3 operating in the 60 GHz band.

The non-AP MLD may initiate multi-link setup by non-AP STA 1 sending an association request frame to AP 1 affiliated with the AP MLD. In the association request frame, the transmitter address (TA) field is set to the MAC address of non-AP STA 1 and the receiver address (RA) field is set to the MAC address of AP 1. The association request frame includes a basic multi-link element that indicates the MLD MAC address of the non-AP MLD and complete information of non-AP STA 1, non-AP STA 2, and non-AP STA 3. The association request frame may request the setup of three links between the non-AP MLD and the AP MLD (a link between AP 1 and non-AP STA 1, a link between AP 2 and non-AP STA 2, and a link between AP 3 and non-AP STA 3).

The AP MLD may respond to the requested multi-link setup by AP sending an association response frame to non-AP STA 1 affiliated with the non-AP MLD. In the association response frame, the TA field is set to the MAC address of the AP 1 and the RA field is set to the MAC address of the non-AP STA 1. The association response frame includes a basic multi-link element that indicates the MLD MAC address of the AP MLD and complete information of AP 1, AP 2, and AP 3. The association response frame signals successful multi-link setup by the setup of three links between the non-AP MLD and AP MLD (link 1 between AP 1 and non-AP STA 1, link 2 between AP 2 and non-AP STA 2, and link 3 between AP 3 and non-AP STA 3).

By default, all TIDs at the non-AP MLD are mapped to all setup links for both uplink and downlink. The TID-to-link mapping mechanism allows an AP MLD and a non-AP MLD that performed or are performing multi-link setup to specify how UL and DL QoS traffic corresponding to different TIDs (e.g., between 0 and 7) may be assigned to the setup links. In a negotiated TID-to-link mapping, a TID may be mapped to a link set, which is a subset of setup links, ranging from a single setup link to all the setup links.

A setup link is defined as enabled for a non-AP MLD if at least one TID is mapped to that link either in DL or in UL and is defined as disabled if no TIDs are mapped to that link both in DL and UL. At any point in time, a TID is always mapped to at least one setup link both in DL and UL, which means that a TID-to-link mapping change can only be valid and successful if it does not result in a TID having a mapped link set made of zero setup links.

By default, all setup links are enabled. If a link is enabled for a non-AP MLD, it may be used for the exchange of individually addressed frames, subject to the power state of the non-AP STA operating on that link. Only MSDUs or A-MSDUs with TIDs mapped to a link may be transmitted on that link in the direction (DL/UL) corresponding to the TID-to-link mapping. Individually addressed management frames and control frames may be sent on any enabled link between an affiliated STA of the non-AP MLD and a corresponding AP of the AP MLD, both in DL and UL.

If a link is disabled for a non-AP MLD, the link may not be used for the exchange of individually addressed frames between an affiliated STA of the non-AP MLD and a corresponding AP of the AP MLD.

If a TID is mapped in UL to a set of enabled links for a non-AP MLD, the non-AP MLD may use any link within this set of enabled links to transmit individually addressed MSDUs or A-MSDUs corresponding to that TID.

If a TID is mapped in DL to a set of enabled links for a non-AP MLD, the non-AP MLD may retrieve individually addressed BUs buffered at the AP MLD that are MSDUs or A-MSDUs corresponding to the TID, on any link of the set of enabled links. Conversely, the AP MLD may use any link within the set of enabled links to transmit individually addressed MSDUs or A-MSDUs corresponding to the TID, subject to the power state of the non-AP STA on each of the used links.

If the default mode is used, the non-AP MLD may retrieve BUs buffered by the AP MLD on any setup link, though the AP MLD may recommend a link.

A non-AP MLD may retrieve buffered BUs that are MMPDUs buffered at the AP MLD on any enabled link. An AP MLD may use any enabled link to transmit individually addressed bufferable management frames that are not measurement MMPDUs, subject to the power state of the non-AP STA on the used link.

If a STA affiliated with a non-AP MLD is in active mode on a link with a set of TIDs mapped for DL transmission, its associated AP affiliated with the AP MLD may transmit to the STA: MSDUs/A-MSDUs for the set of mapped TIDs for the non-AP MLD; and MMPDUs that are not measurement MMPDUs for the non-AP MLD or its affiliated STAs, unless the frames are transmitted to another STA affiliated with the same non-AP MLD and in active mode.

As mentioned above, under the default mapping mode, all TIDs are mapped to all setup links for DL and UL, and all setup links are enabled. A non-AP MLD and an AP MLD that perform multi-link setup shall operate under this mode if a TID-to-link mapping negotiation for a different mapping has not occurred, was unsuccessful, or was torn down.

In a multi-link (re)setup procedure, a non-AP MLD may initiate a TID-to-link mapping negotiation by including a TID-to-link mapping element in a (re)association request frame if an AP MLD has indicated support for TID-to-link mapping negotiation.

After receiving the (re)association request frame containing the TID-to-link mapping element, the AP MLD may reply to the (re)association request frame in according to the following rules. The AP MLD can accept the requested TID-to-link mapping indicated in the TID-to-link mapping element in the received (re)association request frame only if it accepts the multi-link (re)setup for all links on which at least one TID is requested to be mapped. In this case, the non-AP MLD does include in the (re)association response frame a TID-to-link mapping element. Otherwise, the non-AP MLD indicates rejection of the proposed TID-to-link mapping by including in the (re)association response frame a TID-to-link mapping element that suggests a preferred TID-to-link mapping.

Following a successful multi-link (re)setup, to negotiate a new TID-to-link mapping, an initiating MLD may send an individually addressed TID-to-link mapping request frame to a responding MLD that has indicated support of TID-to-link mapping negotiation.

On receiving the individually addressed TID-to-link mapping request frame, the responding MLD sends an individually addressed TID-to-link mapping response frame to the initiating MLD according to the following rules. The responding MLD may accept the requested TID-to-link mapping indicated in the TID-to-link mapping element in the received TID-to-link mapping request frame by transmitting a TID-to-link mapping response frame. Otherwise, the responding MLD may indicate rejection of the proposed TID-to-link mapping in the TID-to-link mapping response frame. The responding MLD may suggest a preferred TID-to-link mapping in the TID-to-link mapping response frame by including the TID-to-link mapping element in the TID-to-link mapping response frame.

An MLD may suggest a preferred TID-to-link mapping to a peer MLD by sending an unsolicited TID-to-link mapping response frame that includes a TID-to-link mapping element.

When a peer MLD indicates a preferred TID-to-link mapping, an MLD may take into account the preferred TID-to-link mapping when it initiates a new TID-to-link mapping. In addition, an AP MLD may take into account the traffic flow(s) affiliated with the non-AP MLD and the capabilities and constraints (if any) of the non-AP MLD.

When two MLDs have negotiated a TID-to-link mapping, either MLD may tear down the negotiated TID-to-link mapping by sending an individually addressed TID-to-link mapping teardown frame. After teardown, the MLDs operates in default mapping mode.

When an MLD successfully negotiates a TID-to-link mapping with a peer MLD, both the MLD and the peer MLD update an uplink and/or downlink TID-to-link mapping information according to the negotiated the TID-to-link mapping.

When an MLD has successfully negotiated with a peer MLD an uplink and/or downlink TID-to-link mapping in which the bit position i of a link mapping field n in the TID-to-link mapping element is set to 0, a TID n shall not be mapped to the link associated with the link ID i in uplink and/or downlink. When an MLD has successfully negotiated with a peer MLD an uplink and/or downlink TID-to-link mapping in which the bit position i of a link mapping field n in the TID-to-link mapping element is set to 1, the TID n is mapped to the link associated with the link ID i in uplink and/or downlink.

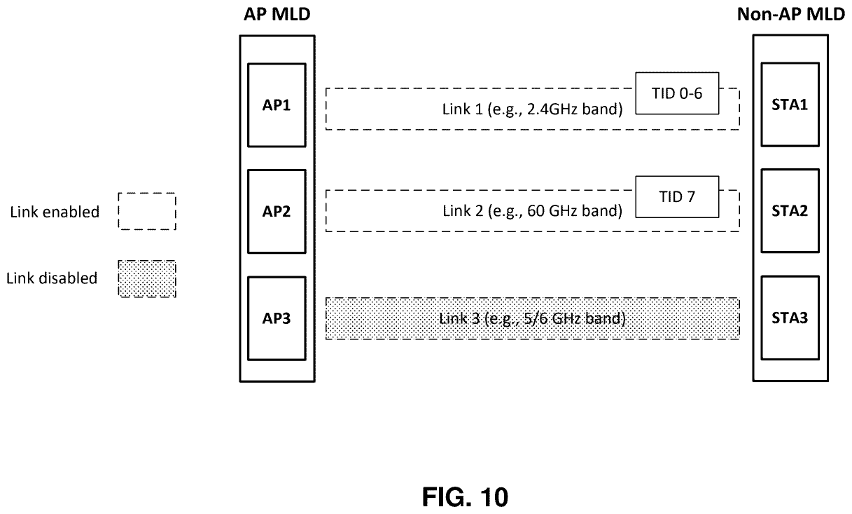

FIG. 10 illustrates an example of a TID-to-link mapping in a multi-link communication environment. As shown, the multi-link communication environment includes an AP MLD having three affiliated APs and a non-AP MLD having three affiliated STAs.

During or after multi-link setup, the non-AP MLD and the AP MLD may negotiate a TID-to-link mapping. The TID-to-link mapping maps TIDs at the non-AP MLD in UL and DL to setup links between the AP MLD and the non-AP MLD. For example, as shown in FIG. 10, the TID-to-link mapping may map TIDs 0-6 in both UL and DL to link 1 and TID 7 in both UL and DL to link 2. As such, links 1 and 2 are enabled, and link 3 is disabled. The TID-to-link mapping negotiation may be performed by exchanging an association request/response frame or a TID-to-link mapping request/response frame between the non-AP MLD and the AP MLD.

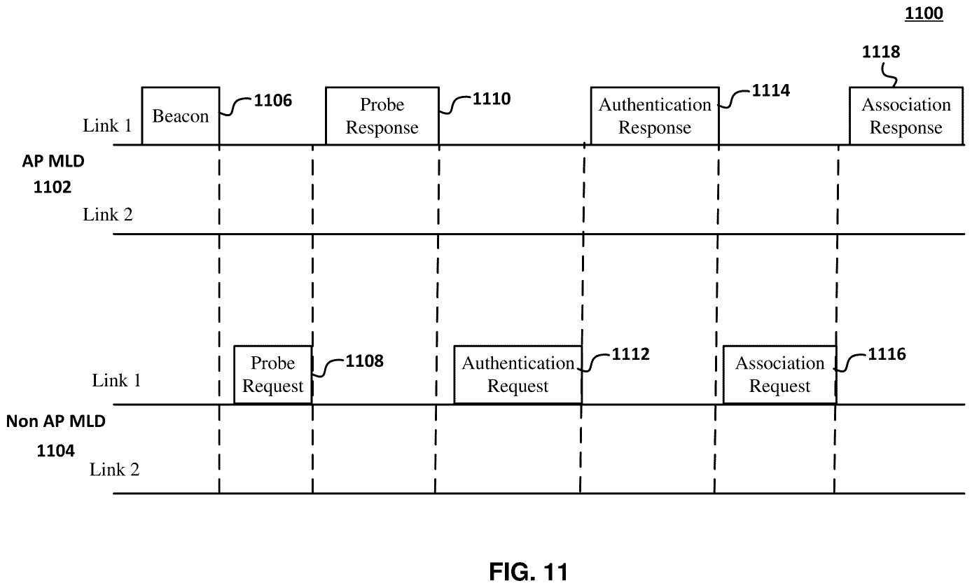

FIG. 11 is an example 1100 that illustrates an association procedure according to the IEEE 802.11 standard. As shown in FIG. 11, example 1100 includes an AP MLD 1102 and a non-AP MLD 1104. AP MLD 1102 and non-AP MLD may each operate on a plurality of links (e.g., link 1 and link 2).

Example 1100 may begin with AP MLD 1102 transmitting a beacon frame 1106 via link 1. Beacon frame 1106 announces the presence of AP MLD 1102 and includes information required by non-AP MLDs to associate with AP MLD 1102. In an example, non-AP MLD 1104 may transmit a probe request frame 1108 via link 1 to discover IEEE 802.11 networks within its proximity. Probe request frame 1108 may indicate the supported data rates and 802.11 capabilities of non-AP MLD 1104. On receiving probe request frame 1108, AP MLD 1102 may check to determine if AP MLD 1102 has at least one common supported data rate with non-AP MLD 1104. If a common data rate exists, AP MLD 1102 may transmit a probe response frame 1110 via link 1 advertising the SSID, supported data rates, encryption types if required, and other 802.11 capabilities of AP MLD 1102. On receiving probe response frame 1110, non-AP MLD 1104 checks its compatibility with AP MLD 1102 and, if compatible, attempts authentication with AP MLD 1102 by sending an authentication request frame 1112 via link 1 to AP MLD 1102. AP MLD 1102 may respond to non-AP MLD 1104 via link 1 with an authentication response frame 1114 for non-AP MLD 1104 to start the association. Subsequently, non-AP MLD 1104 transmits an association request frame 1116 via link 1 to AP MLD 1102. Association request frame 1116 contains chosen encryption types and other compatible IEEE 802.11 capabilities. If the elements of association request frame 1116 match the capabilities of AP MLD 1102, AP MLD 1102 creates an association ID for non-AP MLD 1104 and responds with an association response frame 1118 via link 1 to non-AP MLD 1104. Association response frame 1118 includes a success message granting network access to non-AP MLD 1104.

As illustrated in FIG. 11, once initiated via link 1, the entire association procedure takes place via link 1 until non-AP MLD 1104 is associated with AP MLD 1102. AP MLD 1102 and non-AP MLD 1104 do not use link 2 for completing the association procedure.

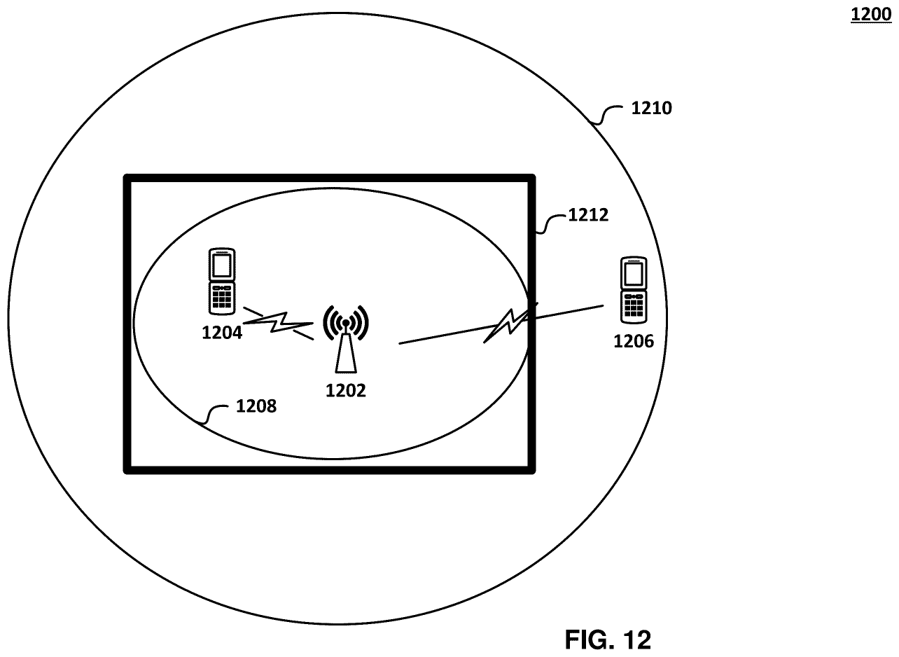

FIG. 12 illustrates an example WLAN communication scenario including an AP MLD 1202, a non-AP MLD 1204, and a non-AP MLD 1206. AP MLD 1202 may be located in a geographical area 1212. Geographical area 1212 may be walled structure, such as a room, an office, an apartment, a building, for example. Non-AP MLD 1204 may also be located within geographical area 1212, while non-AP MLD 1206 may be located outside geographical area 1212.

In an example, AP MLD 1202 may support a plurality of links. The plurality of links may include a first link and a second link. In an example, the first link may be a 2.4 GHz link or a 5/6 GHz link. Using the first link, AP MLD 1202 may have a communication range 1210 as illustrated in FIG. 12. Specifically, using the first link, signals transmitted by AP MLD 1202 may propagate outside of geographical area 1212 and may not be obstructed by physical barriers (e.g., walls) of geographical area 1212. As such, both non-AP MLD 1204 and non-AP MLD 1206 may communicate with AP MLD 1202 via the first link.

In an example, the second link may be a 60 GHz link, an infrared/visible light frequency link. Using the second link, AP MLD 1202 may have a communication range 1208 as illustrated in FIG. 12. Specifically, using the second link, signals transmitted by AP MLD 1202 may not propagate outside of geographical area 1212 as they may be subject to blocking by physical barriers (e.g., walls) of geographical area 1212. As such, only non-AP MLD 1204 may communicate with AP MLD 1202 via the second link.

In an example, AP MLD 1202 may support a private BSS. Access to the private BSS may be limited to authorized users. The authorized users may be users located in geographical area 1212 only. As non-AP MLD 1206 may be located outside geographical area 1212, non-AP MLD 1206 may be a non-authorized user. However, as non-AP MLD 1206 may hear signals of AP MLD 1202 transmitted via the first link, non-AP MLD 1206 may attempt to associate with AP MLD 1202. For example, non-AP MLD 1206 may hear beacon frames transmitted by AP MLD 1202 via the first link and may transmit an association request frame via the first link to AP MLD 1202.

Typically, non-AP MLD 1206 must perform an authentication procedure (as described in FIG. 11 above) with AP MLD 1202 before sending an association request frame to AP MLD 1202. The fact that non-AP MLD 1206 is a non-authorized user, however, may not prevent non-AP MLD 1206 from successful authentication as the existing authentication procedure does not perform an authorization check. As such, non-AP MLD 1206 may be able to associate with AP MLD 1202. Such association may present security risks to the private BSS supported by AP MLD 1202. For example, as a non-authorized user, non-AP MLD 1206 may be a malicious user, such as an eavesdropper or a hacker.

Embodiments of the present disclosure, as further described below, address the above-described problem that may arise in existing IEEE 802.11 networks. In one aspect, an AP may transmit to a STA via a first link a first frame indicating a second link via which performance of an association procedure with the AP is permitted. The AP may receive from the STA an association request via the second link and may transmit an association response via the second link to the STA. In an embodiment, the second link may correspond to a 60 GHz link. As such, association with the AP may be limited to STAs located within a particular geographical area, increasing network security.

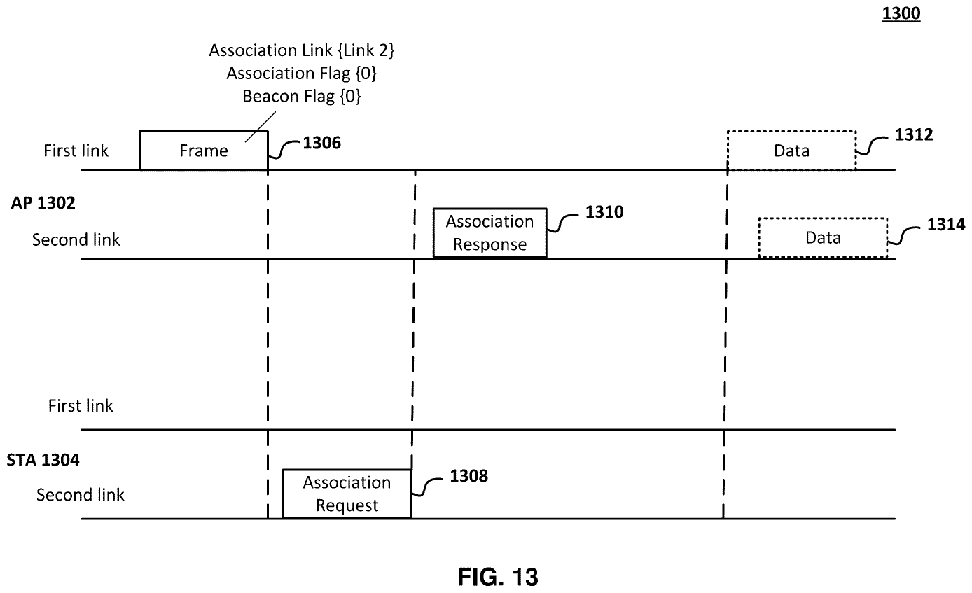

FIG. 13 is an example 1300 that illustrates an association procedure according to an embodiment. As shown in FIG. 13, example 1300 includes an AP 1302 and a STA 1304. AP 1302 and/or STA 1304 may comprise an MLD. As such, AP 1302 and/or STA 1304 may be capable of operating over a plurality of links (e.g., a first link a second link). The first link may correspond to a 2.4 GHz or a 5/6 GHz link. The second link may correspond to a 60 GHz link. At the beginning of example 1300, STA 1304 may be unassociated or associated with another AP and may wish to associate with AP 1302.

As shown in FIG. 13, example 1300 may begin with AP 1302 transmitting a frame 1306 via the first link. Frame 1306 may be a beacon frame or a probe response frame.

In an embodiment, frame 1306 may indicate a link via which performance of an association procedure with AP 1302 is permitted. In an embodiment, the plurality of links over which AP 1302 operates may be divided between links over which a STA may perform an association procedure with AP 1302 and links over which a STA may not perform an association procedure with AP 1302. In an implementation, when a STA attempts to perform an association procedure via a link over which performance of an association procedure is not permitted, the STA may not receive a response (e.g., an association response frame) from AP 1302.

In example 1300, the first link may be a link over which performance of an association procedure with AP 1302 is not permitted and the second link may be a link over which performance of an association procedure with AP 1302 is permitted. As such, in example 1300, frame 1306 may indicate the second link as a link over which performance of an association procedure with AP 1302 is permitted.

In an embodiment, the second link may be part of an exclusive set of links for performing the association procedure with AP 1302. That is, the association procedure with AP 1302 may only be performed using a link of the exclusive set of links. In an embodiment, the exclusive set of links includes the second link only. In an embodiment, where the second link corresponds to the 60 GHz link and where the AP is located in a walled structure, association with the AP may be limited to STAs located within the walled structure. This may increase network security as described above. In another embodiment, the exclusive set of links includes the first link and the second link. In a further embodiment, the exclusive set of links includes the second link and a third link (not shown in FIG. 13.)

In an embodiment, frame 1306 comprises a link identifier field. The link identifier field may indicate a link(s) via which performance of an association procedure with AP 1302 is permitted. In example 1300, the link identifier field may comprise an identifier of the second link. In another example, the link identifier field may further comprise an identifier of the first link.

In another embodiment, frame 1306 may comprise, additionally or alternatively to the link identifier, an association flag that indicates whether performance of the association procedure with AP 1302 via the first link is permitted. In another embodiment, the association flag indicating that performance of the association procedure with AP 1302 via the first link is not permitted indicates that performance of the association procedure with AP 1302 via the second link is permitted. For example, the second link may be a default link for association when the association flag indicates that performance of the association procedure with AP 1302 via the first link is not permitted. In another embodiment, the default link for association, when the association flag indicates that performance of the association procedure with AP 1302 via the first link is not permitted, may be a third link (not shown in FIG. 13).

In example 1300, the link identifier and/or the association flag may indicate the second link as a link via which performance of an association procedure with AP 1302 is permitted. As such, STA 1304 may initiate an association procedure with AP 1302 via the second by transmitting an association request frame 1308 via the second link to AP 1302. AP 1302 may respond to association request frame 1308 by transmitting an association response frame 1310 to STA 1304. In another embodiment, the association procedure may further comprise, prior to the transmission of association request frame 1308, STA 1304 transmitting an authentication request frame to AP 1302 and AP 1302 responding with an authentication response frame to STA 1304.

Subsequently, in an example, AP 1302 may transmit respective data frames 1312 and 1314 via the first link and the second link to STA 1304. As shown in FIG. 13, data frames 1312 and 1314 may overlap in time.

In another embodiment, frame 1306 may further comprise a beacon flag. The beacon flag indicates whether a STA wishing to associate with AP 1302 via a link must wait for a beacon frame (or a probe response frame) on that link before initiating the association procedure with AP 1302. For example, in example 1300, if the link identifier and/or the association flag in frame 1306 indicate the second link as a link via which performance of an association procedure with AP 1302 is permitted, the beacon flag may indicate whether a STA must wait for a beacon frame (or a probe response frame) from AP 1302 on the second link before initiating the association procedure with AP 1302.

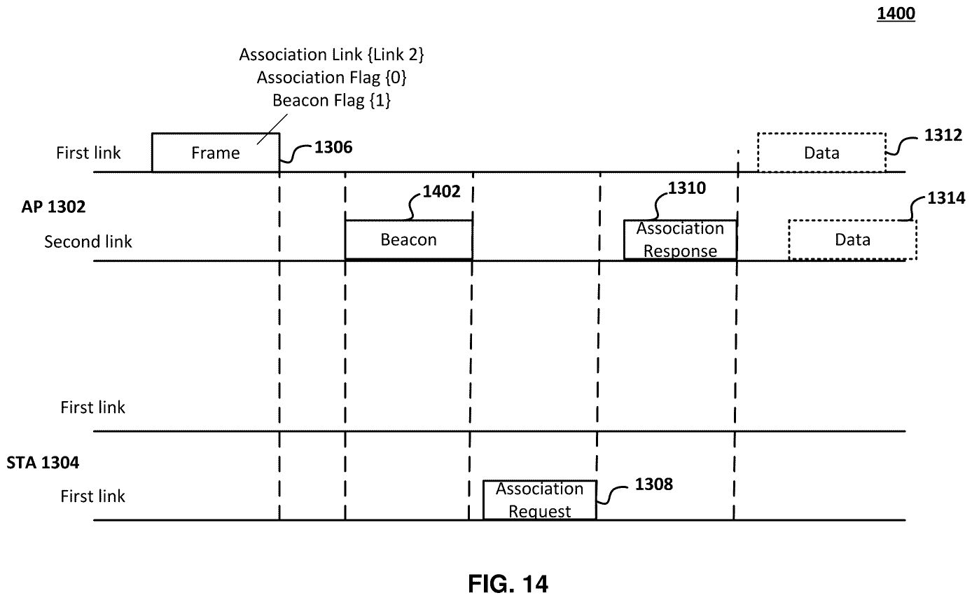

In example 1300, the beacon flag may be set to 0 in frame 1306. As such, as shown in FIG. 13 and described above, STA 1304 may initiate the association procedure with AP 1302 via the second link without waiting for a beacon frame (or a probe response frame) from AP 1302 via the second link. Conversely, as shown in example 1400 illustrated in FIG. 14, when the beacon flag is set to 1 in frame 1306, STA 1304 may wait to hear a beacon frame 1402 (or a probe response frame) via the second link from AP 1302 before initiating the association procedure with AP 1302.

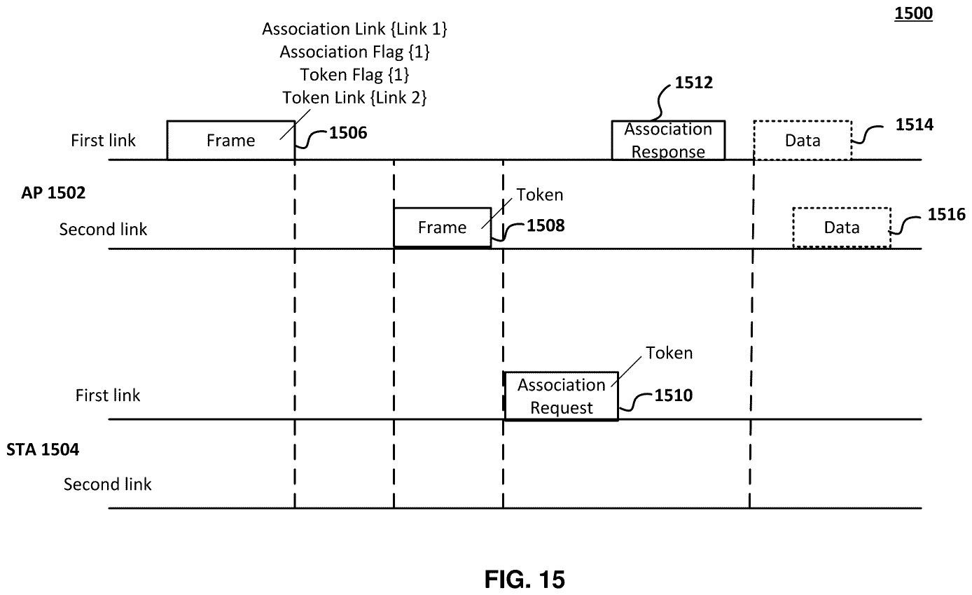

FIG. 15 is an example 1500 that illustrates an association procedure according to another embodiment. As shown in FIG. 15, example 1500 includes an AP 1502 and a STA 1504. AP 1502 and/or STA 1504 may comprise an MLD. As such, AP 1502 and/or STA 1504 may be capable of operating over a plurality of links (e.g., a first link a second link). The first link may correspond to a 2.4 GHz or a 5/6 GHz link. The second link may correspond to a 60 GHz link. At the beginning of example 1500, STA 1504 may be unassociated or associated with another AP and may wish to associate with AP 1502.

As shown in FIG. 15, example 1500 may begin with AP 1502 transmitting a frame 1506 via the first link. Frame 1506 may be a beacon frame or a probe response frame.

In an embodiment, frame 1506 may indicate a link via which performance of an association procedure with AP 1502 is permitted. In an embodiment, the plurality of links over which AP 1502 operates may be divided between links over which a STA may perform an association procedure with AP 1502 and links over which a STA may not perform an association procedure with AP 1502. In an implementation, when a STA attempts to perform an association procedure via a link over which performance of an association procedure is not permitted, the STA may not receive a response (e.g., an association response frame) from AP 1502.

In example 1500, the first link may be a link over which performance of an association procedure with AP 1502 is permitted and the second link may be a link over which performance of an association procedure with AP 1502 is not permitted. As such, in example 1500, frame 1506 may indicate the first link as a link over which performance of an association procedure with AP 1502 is permitted.

In an embodiment, the first link may be part of an exclusive set of links for performing the association procedure with AP 1502. That is, the association procedure with AP 1502 may only be performed using a link of the exclusive set of links. In an embodiment, the exclusive set of links includes the first link only. In another embodiment, the exclusive set of links includes the first link and the second link. In a further embodiment, the exclusive set of links includes the second link and a third link (not shown in FIG. 15.)

In an embodiment, frame 1506 comprises a link identifier field. The link identifier field may indicate a link(s) via which performance of an association procedure with AP 1502 is permitted. In example 1500, the link identifier field may comprise an identifier of the first link. In another example, the link identifier field may further comprise an identifier of the second link.

In another embodiment, frame 1506 may comprise, additionally or alternatively to the link identifier, an association flag that indicates whether performance of the association procedure with AP 1502 via the first link is permitted. In another embodiment, the association flag indicating that performance of the association procedure with AP 1502 via the first link is not permitted indicates that performance of the association procedure with AP 1502 via the second link is permitted. For example, the second link may be a default link for association when the association flag indicates that performance of the association procedure with AP 1502 via the first link is not permitted. In another embodiment, the default link for association, when the association flag indicates that performance of the association procedure with AP 1502 via the first link is not permitted, may be a third link (not shown in FIG. 15).

In example 1500, the link identifier and/or the association flag may indicate the first link as a link via which performance of an association procedure with AP 1502 is permitted.

In an embodiment, frame 1506 may comprise a token flag that indicates presence or absence of an association token. The association token may be included in a frame transmitted by AP 1502 via the first link, the second link, or a third link.

In an embodiment, frame 1506 may further comprise a token link identifier field. The token link identifier field may indicate a link(s) via which the frame including the association token is transmitted.

In example 1500, frame 1506 includes a token flag set to 1 which indicates presence of the association token. Frame 1506 further includes a token link identifier field comprising an identifier of the second link. As such, AP 1502 may transmit via the second link a frame 1508 that includes the association token. Frame 1508 may be a beacon frame or a probe response frame.

In an example, STA 1504 may receive frame 1508 and may retrieve the association token from frame 1508. Subsequently, STA 1504 may initiate an association procedure with AP 1502 via the first link by transmitting an association request frame 1510, which comprises the association token, via the first link to AP 1502. AP 1502 may respond to association request frame 1510 by transmitting an association response frame 1512 to STA 1304. In another embodiment, the association procedure may further comprise, prior to the transmission of association request frame 1510, STA 1504 transmitting an authentication request frame to AP 1502 and AP 1502 responding with an authentication response frame to STA 1504.

Subsequently, in an example, AP 1502 may transmit respective data frames 1514 and 1516 via the first link and the second link to STA 1504. As shown in FIG. 15, data frames 1514 and 1516 may overlap in time.

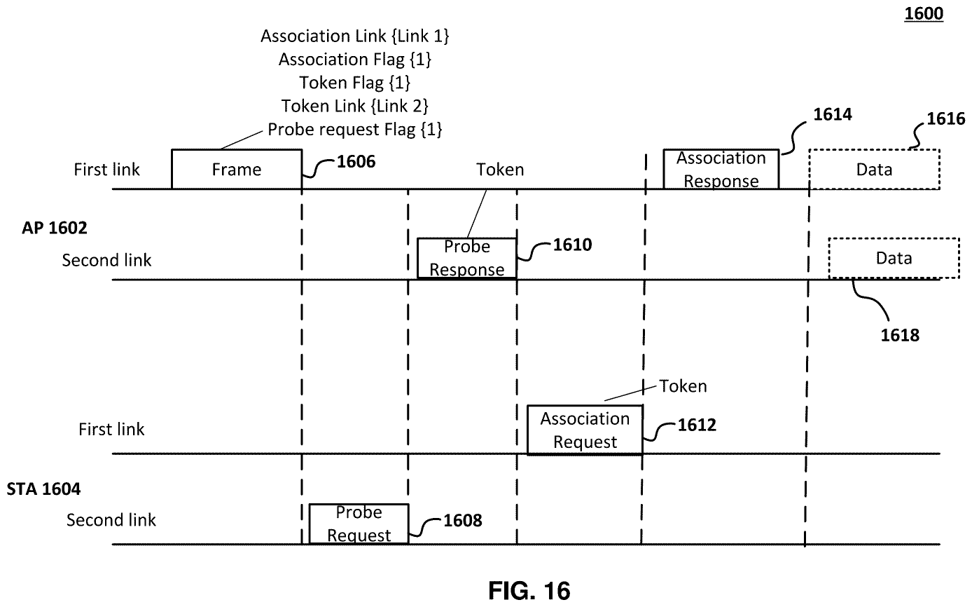

FIG. 16 is an example 1600 that illustrates another association procedure according to an embodiment. As shown in FIG. 16, example 1600 includes an AP 1602 and a STA 1604. AP 1602 and/or STA 1604 may comprise an MLD. As such, AP 1602 and/or STA 1604 may be capable of operating over a plurality of links (e.g., a first link a second link). The first link may correspond to a 2.4 GHz or a 5/6 GHz link. The second link may correspond to a 60 GHz link. At the beginning of example 1600, STA 1604 may be unassociated or associated with another AP and may wish to associate with AP 1602.

As shown in FIG. 16, example 1600 may begin with AP 1602 transmitting a frame 1606 via the first link. Frame 1606 may be a beacon frame or a probe response frame.

In an embodiment, frame 1606 may indicate a link via which performance of an association procedure with AP 1602 is permitted. In an embodiment, the plurality of links over which AP 1602 operates may be divided between links over which a STA may perform an association procedure with AP 1602 and links over which a STA may not perform an association procedure with AP 1602. In an implementation, when a STA attempts to perform an association procedure via a link over which performance of an association procedure is not permitted, the STA may not receive a response (e.g., an association response frame) from AP 1602.

In example 1600, the first link may be a link over which performance of an association procedure with AP 1602 is permitted and the second link may be a link over which performance of an association procedure with AP 1602 is not permitted. As such, in example 1600, frame 1606 may indicate the first link as a link over which performance of an association procedure with AP 1602 is permitted.

In an embodiment, the first link may be part of an exclusive set of links for performing the association procedure with AP 1602. That is, the association procedure with AP 1602 may only be performed using a link of the exclusive set of links. In an embodiment, the exclusive set of links includes the first link only. In another embodiment, the exclusive set of links includes the first link and the second link. In a further embodiment, the exclusive set of links includes the second link and a third link (not shown in FIG. 16.)

In an embodiment, frame 1606 comprises a link identifier field. The link identifier field may indicate a link(s) via which performance of an association procedure with AP 1602 is permitted. In example 1600, the link identifier field may comprise an identifier of the first link. In another example, the link identifier field may further comprise an identifier of the second link.

In another embodiment, frame 1606 may comprise, additionally or alternatively to the link identifier, an association flag that indicates whether performance of the association procedure with AP 1602 via the first link is permitted. In another embodiment, the association flag indicating that performance of the association procedure with AP 1602 via the first link is not permitted indicates that performance of the association procedure with AP 1602 via the second link is permitted. For example, the second link may be a default link for association when the association flag indicates that performance of the association procedure with AP 1602 via the first link is not permitted. In another embodiment, the default link for association, when the association flag indicates that performance of the association procedure with AP 1602 via the first link is not permitted, may be a third link (not shown in FIG. 16).

In example 1600, the link identifier and/or the association flag may indicate the first link as a link via which performance of an association procedure with AP 1602 is permitted.

In an embodiment, frame 1606 may comprise a token flag that indicates presence or absence of an association token. The association token may be included in a frame transmitted by AP 1602 via the first link, the second link, or a third link.

In an embodiment, frame 1606 may further comprise a token link identifier field. The token link identifier field may indicate a link(s) via which the frame including the association token is transmitted.

In an embodiment, frame 1606 may further indicate whether STA 1604 is required to transmit a probe request to AP 1602 to obtain the association token from the AP 1602. In an embodiment, frame 1606 may include a probe request flag for this indication.

In example 1600, frame 1606 includes a token flag set to 1 which indicates presence of the association token. Frame 1606 further includes a token link identifier field comprising an identifier of the second link and a probe request flag set to 1.

As such, after receiving frame 1606, STA 1604 may initiate an association procedure with AP 1602 via the first link by transmitting a probe request frame 1608 via the second link (indicated by the token link identifier in frame 1606). AP 1602 responds to probe request frame 1608 with a probe response frame 1610 comprising the association token. Upon receiving probe response frame 1610, STA 1604 retrieves the association token and transmits an association request frame 1612, which includes the association token, via the second link (indicated as the association link in frame 1606). AP 1602 may respond to association request frame 1612 by transmitting an association response frame 1614 to STA 1604. In another embodiment, the association procedure may further comprise, prior to the transmission of association request frame 1612, STA 1604 transmitting an authentication request frame to AP 1602 and AP 1602 responding with an authentication response frame to STA 1604.

In another embodiment, frame 1606 may indicate whether STA 1604 is required to transmit a request to AP 1602 to obtain the association token from the AP 1602. In an embodiment, frame 1606 may include a request flag for this indication (not shown in FIG. 16). In an embodiment, STA 1604 may transmit a frame requesting the association token via the second link upon receiving frame 1606 with a request flag set to 1. In an embodiment, AP 1602 responds to the frame requesting the association token with a response frame comprising the association token. Upon receiving the response frame, STA 1604 retrieves the association token and transmits an association request frame 1612, which includes the association token, via the second link (indicated as the association link in frame 1606). AP 1602 may respond to association request frame 1612 by transmitting an association response frame 1614 to STA 1604. In another embodiment, the association procedure may further comprise, prior to the transmission of association request frame 1612, STA 1604 transmitting an authentication request frame to AP 1602 and AP 1602 responding with an authentication response frame to STA 1604.

Subsequently, in an example, AP 1602 may transmit respective data frames 1616 and 1618 via the first link and the second link to STA 1604. As shown in FIG. 16, data frames 1616 and 1618 may overlap in time.

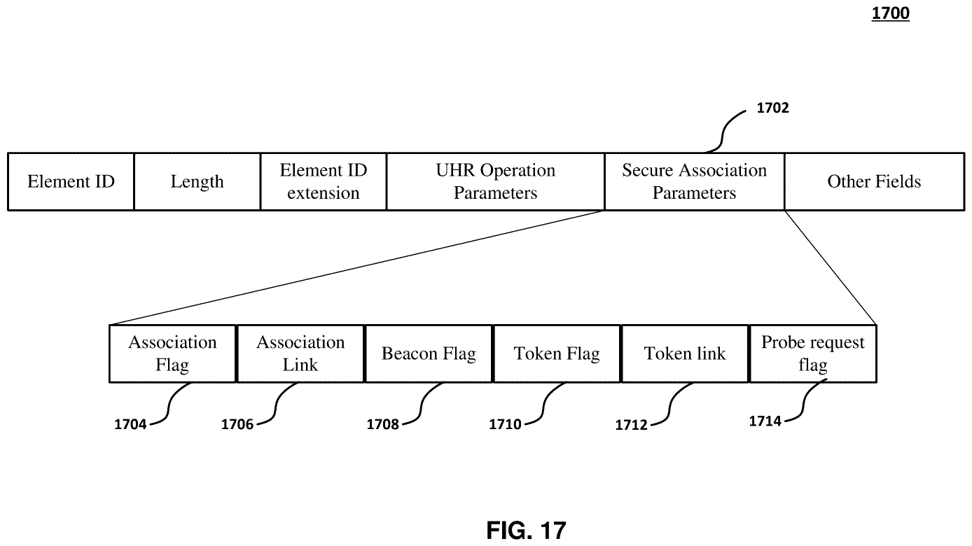

FIG. 17 illustrates an example operation element which may be used in embodiments. As shown, the example operation element may include an element ID field, a length field, an element ID extension, a UHR operation parameters field, a secure association parameters field 1702, and other fields.

The element ID field and, if present, the element ID extension field identify the operation element.

The length field indicates the number of octets in the element excluding the element ID and length fields.

The UHR operation parameters field provides information for operation according to a specific PHY layer (UHR).

The secure association parameters field 1702 may comprise an association flag field 1704, an association link field 1706, a beacon flag field 1708, a token flag field 1710, a token link field 1712, and a probe request flag field 1714. These fields include, respectively, the association flag, association link, beacon flag, token flag, token link, and probe request flag described above. As would be understood by a person of skill in the art based on the teachings herein, when one of the secure associations parameters (e.g., beacon flag, probe request flag, etc.) is not present in a particular embodiment, the respective field in secure association parameters field 1702 may also not be present.

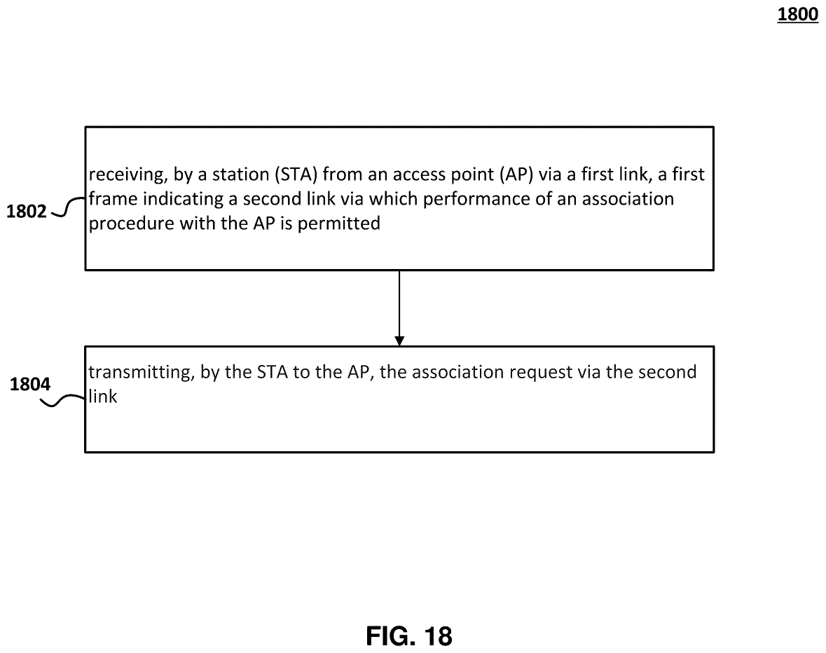

FIG. 18 illustrates an example process 1800 according to an embodiment. Example process 1800 is provided for the purpose of illustration only and is not limiting embodiments. Process 1800 may be performed by a STA, such as STA 1304, 1504, or 1604. The STA may comprise a non-AP MLD.

Step 1802 includes receiving, by the STA from an AP via a first link, a first frame indicating a second link via which performance of an association procedure with the AP is permitted. The first link may correspond to a 2.4 GHz or a 5/6 GHz link. The second link may correspond to a 60 GHz link. The STA may be capable of operating over a plurality of links, including the first link and the second link.

In an embodiment, the first frame comprises a beacon frame or a probe response frame.

In an embodiment, the first frame comprises a link identifier field. The link identifier field may indicate a link(s) via which performance of an association procedure with the AP is permitted. In an embodiment, the link identifier field comprises an identifier of the second link.

In an embodiment the first frame comprises a flag that indicates whether performance of the association procedure with the AP via the first link is permitted.

In an embodiment, the flag indicating that performance of the association procedure with the AP via the first link is not permitted indicates that performance of the association procedure with the AP via the second link is permitted.

In an embodiment, the first frame comprises a beacon flag. The beacon flag indicates whether a STA wishing to associate with AP via a link must wait for a beacon frame (or a probe response frame) on that link before initiating the association procedure with AP.

In an embodiment, the first frame may comprise a token flag that indicates presence or absence of an association token. The association token may be included in a frame transmitted by the AP via the first link, the second link, or a third link.

In an embodiment, the first frame may further comprise a token link identifier field. The token link identifier field may indicate a link(s) via which the frame including the association token is transmitted.

In an embodiment, the first frame comprises a probe request flag that indicates whether the STA is required to send a probe request frame to obtain the association token from the AP. In another embodiment the first frame comprises a request flag that indicates whether the STA is required to send a frame requesting to obtain the association token from the AP.

In an embodiment, the second link is part of an exclusive set of links for performing the association procedure with the AP.

In an embodiment, the exclusive set of links includes the second link only. In an embodiment, where the second link corresponds to a 60 GHz link and where the AP is located in a walled structure, association with the AP may be limited to STAs located within the walled structure. In another embodiment, the exclusive set of links includes the first link and the second link.

Step 1804 includes transmitting, by the STA to the AP MLD, the association request via the second link.

In an embodiment, process 1800 may further comprise receiving an association response from the AP. In an embodiment, process 1800 further comprises transmitting an authentication request frame to the AP and receiving an authentication response frame from the AP.

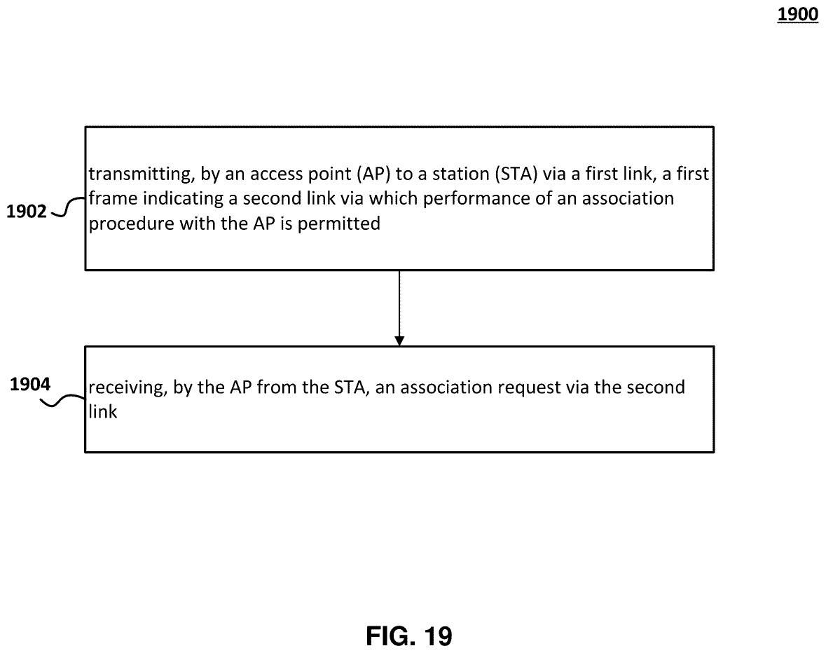

FIG. 19 illustrates an example process 1900 according to an embodiment. Example process 1900 is provided for the purpose of illustration only and is not limiting embodiments. Process 1900 may be performed by an AP, such as AP 1302, 1502, or 1602. The AP may be an AP MLD.

Step 1902 includes transmitting, by the AP to a STA via a first link, a first frame indicating a second link via which performance of an association procedure with the AP is permitted. The first link may correspond to a 2.4 GHz or a 5/6 GHz link. The second link may correspond to a 60 GHz link. The AP may be capable of operating over a plurality of links, including the first link and the second link.

In an embodiment, the first frame comprises a beacon frame or a probe response frame.

In an embodiment the first frame comprises a link identifier field. The link identifier field may indicate a link(s) via which performance of an association procedure with the AP is permitted. In an embodiment, the link identifier field comprises an identifier of the second link.

In an embodiment the first frame comprises a flag that indicates whether performance of the association procedure with the AP via the first link is permitted.

In an embodiment, the flag indicating that performance of the association procedure with the AP via the first link is not permitted indicates that performance of the association procedure with the AP via the second link is permitted.

In an embodiment, the first frame comprises a beacon flag. The beacon flag indicates whether a STA wishing to associate with AP via a link must wait for a beacon frame (or a probe response frame) on that link before initiating the association procedure with AP.

In an embodiment, the first frame may comprise a token flag that indicates presence or absence of an association token. The association token may be included in a frame transmitted by the AP via the first link, the second link, or a third link.

In an embodiment, the first frame may further comprise a token link identifier field. The token link identifier field may indicate a link(s) via which the frame including the association token is transmitted.

In an embodiment, the first frame comprises a probe request flag that indicates whether the STA is required to send a probe request frame to obtain the association token from the AP.

In an embodiment, the second link is part of an exclusive set of links for performing the association procedure with the AP.

In an embodiment, the exclusive set of links includes the second link only. In another embodiment, the exclusive set of links includes the first link and the second link.

Step 1904 includes receiving, by the AP from the STA, an association request via the second link.

In an embodiment, process 1900 may further comprise transmitting an association response to the STA. In an embodiment, process 1900 further comprises receiving an authentication request frame from the STA and transmitting an authentication response frame to the STA.

What is claimed is:

1. A station (STA) comprising:
one or more processors; and
memory storing instructions that, when executed by the one or more processors, cause the STA to:
receive, from an access point (AP) via a first link, a first frame indicating a second link via which performance of an association procedure with the AP is permitted; and
transmit, to the AP and via the first link, an association request for the second link.

2. The STA of claim 1, wherein the AP comprises an AP multi-link device (AP MLD) and the STA comprises a non-AP STA MLD.

3. The STA of claim 1, wherein the first link corresponds to a 2.4 GHz link, a 5 GHz link, or a 6 GHz link.

4. The STA of claim 3, wherein the second link corresponds to a 60 GHz link.

5. The STA of claim 4, wherein the first frame comprises a beacon frame or a probe response frame.

6. The STA of claim 4, wherein the first frame indicates presence or absence of an association token in a second frame transmitted by the AP via the second link.

7. The STA of claim 6, wherein the second frame transmitted by the AP via the second link comprises the association token, and wherein the association request comprises the association token.

8. An access point (AP) comprising:
one or more processors; and
memory storing instructions that, when executed by the one or more processors, cause the AP to:
transmit, to a station (STA) via a first link, a first frame indicating a second link via which performance of an association procedure with the STA is permitted; and
receive, from the AP and via the first link, an association request for the second link.

9. The AP of claim 8, wherein the AP comprises an AP multi-link device (AP MLD) and the STA comprises a non-AP STA MLD.

10. The AP of claim 8, wherein the first link corresponds to a 2.4 GHz link, a 5 GHz link, or a 6 GHz link.

11. The AP of claim 10, wherein the second link corresponds to a 60 GHz link.

12. The AP of claim 11, wherein the first frame comprises a beacon frame or a probe response frame.

13. The AP of claim 11, wherein the first frame indicates presence or absence of an association token in a second frame transmitted by the AP via the second link.

14. The AP of claim 13, wherein the second frame transmitted by the AP via the second link comprises the association token, and wherein the association request comprises the association token.

15. A non-transitory computer-readable medium comprising instructions that, when executed by one or more processors of a station (STA), cause the STA to:
receive, from an access point (AP) via a first link, a first frame indicating a second link via which performance of an association procedure with the AP is permitted; and
transmit, to the AP and via the first link, an association request for the second link.

16. The non-transitory computer-readable medium of claim 15, wherein the AP comprises an AP multi-link device (AP MLD) and the STA comprises a non-AP STA MLD.

17. The non-transitory computer-readable medium of claim 15, wherein the first link corresponds to a 2.4 GHz link, a 5 GHz link, or a 6 GHz link.

18. The non-transitory computer-readable medium of claim 17, wherein the second link corresponds to a 60 GHz link.

19. The non-transitory computer-readable medium of claim 18, wherein the first frame comprises a beacon frame or a probe response frame.

20. The non-transitory computer-readable medium of claim 18, wherein the first frame indicates presence or absence of an association token in a second frame transmitted by the AP via the second link.
